(19) United States
(12) Patent Application Publication
(10) Pub. No.: US 2022/0352732 A1
(43) Pub. Date: Nov. 3, 2022

(54) PORTABLE ELECTRONIC DEVICE AND CHARGING SYSTEM THEREOF

(71) Applicant: ASUSTeK COMPUTER INC., Taipei (TW)

(72) Inventors: Tsung-Lin HO, Taipei (TW); Han-Wei TANG, Taipei (TW)

(21) Appl. No.: 17/729,105

(22) Filed: Apr. 26, 2022

(30) Foreign Application Priority Data
Apr. 28, 2021 (TW) 110115407

(51) Int. Cl. H02J 7/00; G06F 1/16; G06F 1/26

(52) U.S. Cl. CPC H02J 7/0042; G06F 1/1626; G06F 1/1632; G06F 1/1656; G06F 1/26; H01R 13/22

(57) ABSTRACT

A portable electronic device and a charging system are provided. The portable electronic device includes a display screen, a base, and a charging circuit. The base is connected to the display screen, to cause the display screen to rotate relative to the base. The charging circuit is disposed in the base and includes a first conductive terminal and a second conductive terminal. The first conductive terminal and the second conductive terminal are exposed on a bottom surface of the portable electronic device. The charging system further includes a power supply device. When the portable electronic device is placed on the power supply device, the first conductive terminal and the second conductive terminal come into contact with a plurality of charging electrodes, to form electrical connections to the power supply device and receive charging power.

### CROSS-REFERENCE TO RELATED APPLICATION

This application claims the priority benefit of Taiwan Application Serial No. 110115407, filed on Apr. 28, 2021. The entirety of the above-mentioned patent application is hereby incorporated by reference herein and made a part of the specification.

### BACKGROUND OF THE INVENTION

### Field of the Invention

The present disclosure relates to a portable electronic device and a charging system thereof.

### Description of the Related Art

With the popularity of various mobile electronic devices such as smartphones, tablet computers, and notebook computers, an increasing quantity of factors are considered by a consumer during purchase. For example, a battery capacity and a charging mode of a mobile electronic device are important factors.

Currently, although there are wireless charging technologies for generating charging power through coil coupling, configuration of a coil requires occupation of a specific volume, making it difficult to apply the wireless charging technologies to light and slim portable electronic devices. In addition, problems, such as magnetic interference and heat dissipation, also need to be resolved. Therefore, wireless charging is not a perfect charging mode.

### BRIEF SUMMARY OF THE INVENTION

According to the first aspect, a portable electronic device is provided. The portable electronic device is adapted to match a power supply device including a plurality of charging electrodes. The portable electronic device includes a display screen, a base, and a charging circuit. The base is connected to the display screen, to cause the display screen to rotate relative to the base. The charging circuit is disposed in the base and includes a first conductive terminal and a second conductive terminal. The first conductive terminal and the second conductive terminal are exposed on a bottom surface of the portable electronic device. When the portable electronic device is placed on the power supply device, the first conductive terminal and the second conductive terminal come into contact with the charging electrodes, to form electrical connections and receive charging power.

According to the second aspect, a charging system including a portable electronic device and a power supply device is provided. The portable electronic device includes a display screen, a base, and a charging circuit. The base is connected to the display screen, to cause the display screen to rotate relative to the base. The charging circuit is disposed in the base and includes a first conductive terminal and a second conductive terminal, and the first conductive terminal and the second conductive terminal are exposed on a bottom surface of the portable electronic device. The power supply device includes a plurality of charging electrodes. When the portable electronic device is placed on the power supply device, the first conductive terminal and the second conductive terminal come into contact with at least two of the charging electrodes to form electrical connections, to cause the power supply device to supply charging power to the portable electronic device through the charging electrodes, the first conductive terminal and the second conductive terminal.

In the present disclosure, a plurality of conductive terminals is configured at a bottom of the portable electronic device, so that when the portable electronic device is placed on the power supply device, the portable electronic device come into direct contact with a plurality of charging electrodes on the power supply device, to form a charging loop, thereby improving charging convenience.

### BRIEF DESCRIPTION OF THE DRAWINGS

FIG. 1 is a schematic diagram of a charging system according to some embodiments of the present disclosure;

FIG. 2A and FIG. 2B are schematic diagrams of a portable electronic device according to some embodiments of the present disclosure;

FIG. 2C is a schematic diagram of a usage mode of a charging system according to some embodiments of the present disclosure;

FIG. 3A to FIG. 3C are schematic diagrams of a conductive terminal according to some embodiments of the present disclosure;

FIG. 4A and FIG. 4B are schematic diagrams of a conductive terminal according to some embodiments of the present disclosure;

FIG. 5A to FIG. 5D are schematic diagrams of a conductive terminal according to some embodiments of the present disclosure; and

FIG. 6A and FIG. 6B are schematic diagrams of a conductive terminal according to some embodiments of the present disclosure.

### DETAILED DESCRIPTION OF THE EMBODIMENTS

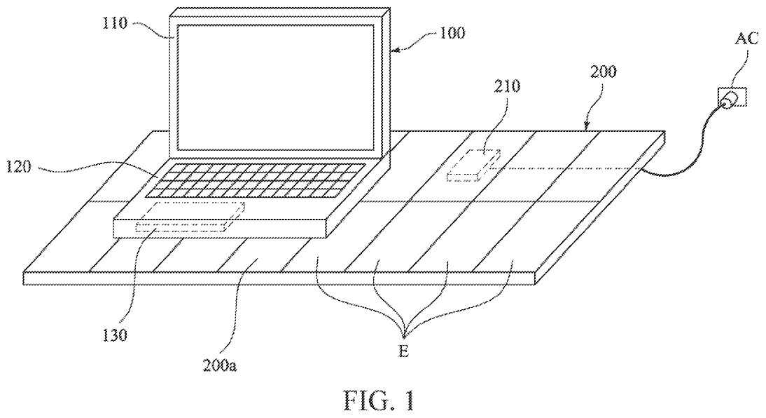

Referring to FIG. 1, a charging system includes a portable electronic device 100 and a power supply device 200. In an embodiment, the portable electronic device 100 is a notebook computer. However, in another embodiment, the portable electronic device 100 is alternatively a tablet computer, a smartphone, or another device.

The portable electronic device 100 includes a display screen 110, a base 120, and a charging circuit 130. The display screen 110 is configured to display a plurality of pixels, to present a display screen. The base 120 is connected (in an embodiment, is connected pivotally or hingedly) to the display screen 110, to enable the display screen 110 to rotate relative to the base 120. In an embodiment, an input apparatus (such as a keyboard and a touch panel) is disposed on the base 120, and a processor (not shown in the figure) and a battery are disposed in the base 120. The processor is electrically connected to the battery, the input apparatus, and the display screen 110 for performing various operations.

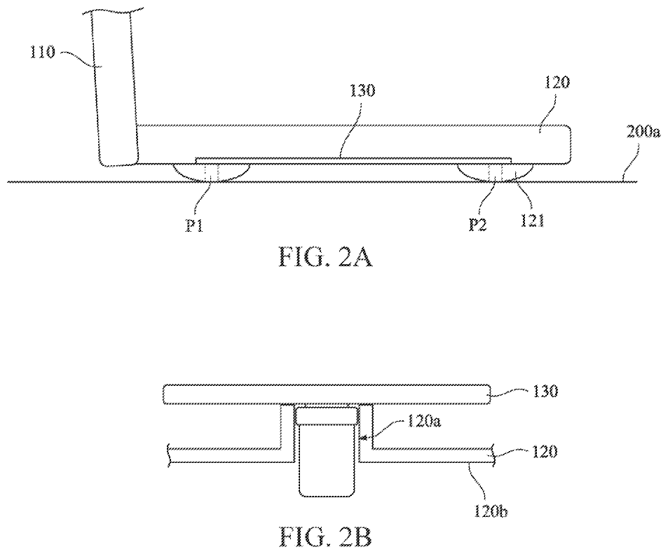

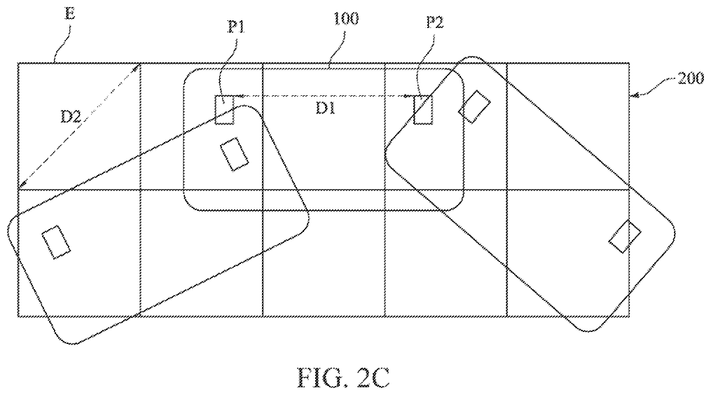

The charging circuit 130 is disposed in the base 120, is electrically connected to the processor and the battery, and includes a first conductive terminal P1 and a second conductive terminal P2. FIG. 2A is a schematic diagram of a conductive terminal according to some embodiments of the present disclosure. In an embodiment, bottom ends of the first conductive terminal P1 and the second conductive terminal P2 are contact ends that are exposed on a bottom surface 120b of the base 120 (in an embodiment, pass through an opening in a bottom of the base 120 and extend from a support pad 121).

In an embodiment, the portable electronic device 100 is electrically connected to a power terminal AC (in an embodiment, a mains) through an original power port (not shown in the figure), to receive power and charge a battery inside the portable electronic device 100. In other words, the charging circuit 130, and the first conductive terminal P1 and the second conductive terminal P2 of the charging circuit 130 are used as another charging mode of the portable electronic device 100, to improve use flexibility.

The power supply device 200 is configured to supply power to the portable electronic device 100 through the first conductive terminal P1 and the second conductive terminal P2. The power supply device 200 includes a charging controller 210 and a plurality of charging electrodes E. In an embodiment, the charging controller 210 is electrically connected to the power terminal AC (in an embodiment, a mains) for converting an alternating current into direct current charging power. The charging electrodes E is electrically connected to the charging controller 210 for receiving the charging power. In an embodiment, the charging electrodes E is plate-shaped, and in an embodiment, is implemented as a “charging brick”. Top surfaces of the charging electrodes E are exposed on a placement plane 200a of the power supply device 200, and are flush with the placement plane 200a (or are used to form the placement plane). When the portable electronic device 100 is placed on the placement plane of the power supply device 200, the contact end (the bottom end shown in FIG. 2A) of the first conductive terminal P1 and the contact end (the bottom end shown in FIG. 2A) of the second conductive terminal P2 are flush with the bottom surface of the base 120, so that the first conductive terminal P1 and the second conductive terminal P2 come into contact with a charging electrodes E individually and flatly, to form electrical connections to the power supply device 200. In this case, a charging loop is formed by charging power of the power supply device 200 through the charging electrodes E, the first conductive terminal P1, and the second conductive terminal P2, to supply charging power to the charging circuit 130.

Based on this, because when the first conductive terminal P1 and the second conductive terminal P2 are placed on the power supply device 200, the first conductive terminal P1 and the second conductive terminal P2 come into direct contact with the plurality of charging electrodes on the power supply device 200, to form the charging loop, charging convenience of the portable electronic device 100 is improved.

As shown in FIG. 2A, in an embodiment, a plurality of support pads 121 is disposed at the bottom of the base 120. The support pad 121 is made of a frictional material (in an embodiment, rubber). The first conductive terminal P1 and the second conductive terminal P2 are disposed in the support pad 121, so that the contact ends are exposed on a bottom of the support pad 121. The first conductive terminal P1 and the second conductive terminal P2 are combined with the support pad 121, to not only reduce space configuration of the base 120, but also make contact between the first conductive terminal P1 and the second conductive terminal P2 and the power supply device 200 more stable.

In some embodiments, the first conductive terminal P1 and the second conductive terminal P2 alternatively protrude out of the support pad 121. FIG. 2B is a schematic diagram of a first conductive terminal according to some embodiments of the present disclosure. In this embodiment, the bottom of the base 120 is provided with a first slot 120a. At least a part of the first conductive terminal P1 is fixed into the first slot 120a and is exposed on the bottom of the base 120. Similarly, the bottom of the base 120 is provided with a second slot the same as the first slot 120a. At least a part of the second conductive terminal P2 is fixed into the second slot and is exposed on the bottom of the base 120.

In an embodiment, as shown in FIG. 1, an area of the placement plane is greater than or equal to an area of the bottom surface of the base 120. In another embodiment, a width of the placement plane is greater than or equal to a distance between the first conductive terminal P1 and the second conductive terminal P2. The charging controller 210 of the power supply device 200 is electrically connected to the charging electrodes E, and is configured to determine which charging electrodes E are in contact with the first conductive terminal P1 or the second conductive terminal P2. After two charging electrodes E in contact with the first conductive terminal P1 and the second conductive terminal P2 are determined by the charging controller 210, the two charging electrodes E are respectively determined by the charging controller 210 as a positive electrode and a negative electrode for charging, and the two charging electrodes E are connected to the power supply circuit in the power supply device 200, to build the charging loop for charging the portable electronic device 100.

FIG. 2C is a schematic diagram of a usage mode of a charging system according to some embodiments of the present disclosure. In an embodiment, a distance D1 between the contact end of the first conductive terminal P1 and the contact end of the second conductive terminal P2 is greater than a diagonal length D2 of each of the charging electrodes E. Based on this, regardless of any position (in an embodiment, three placement positions shown in FIG. 2C) in which the portable electronic device 100 is placed on the placement plane, the first conductive terminal P1 and the second conductive terminal P2 do not come into contact with the same charging electrode E, to avoid forming a short circuit. In some embodiments, the distance D1 between the contact end of the first conductive terminal P1 and the contact end of the second conductive terminal P2 is at least greater than 5 cm. The distance D1 is adjustable according to actual requirements.

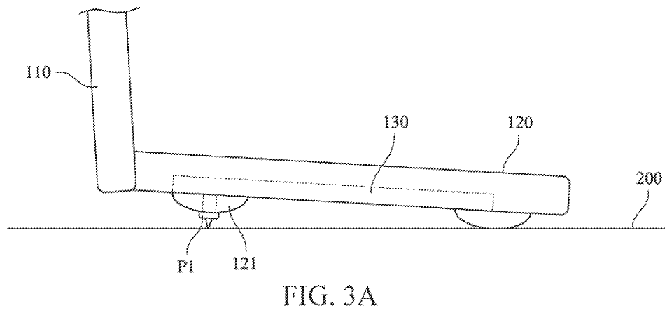

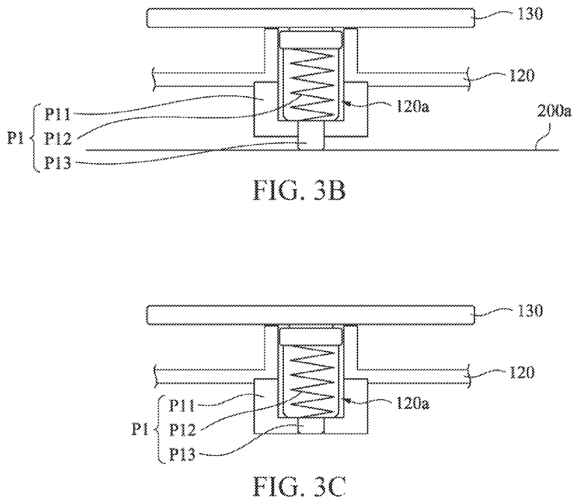

FIG. 3A to FIG. 3C are schematic diagrams of a first conductive terminal P1 according to some embodiments of the present disclosure. In an embodiment, when the first conductive terminal P1 and the second conductive terminal P2 come into contact with the charging electrodes E, the first conductive terminal P1 and the second conductive terminal P2 are displaced along the first slot 120a and the second slot (not shown in the figure). Specifically, the first conductive terminal P1 includes a pad body P11, a first spring P12, and a terminal assembly P13. The pad body P11 is disposed at the bottom of the base 120, to serve as a non-slip pad (in an embodiment, the support pad 121 shown in FIG. 2A) of the portable electronic device 100. The first spring P12 is fixed into the base 120, and the terminal assembly P13 protrudes from the pad body P11. As shown in FIG. 3B, one end of the first spring P12 abuts against a casing of the base 120 or an inner wall of the first slot 120a. An other end of the first spring P12 is connected to the terminal assembly P13. As shown in FIG. 3C, when the portable electronic device 100 is placed on the placement plane 200a of the power supply device 200, the terminal assembly P13 is pushed into the base 120, to cause the first spring P12 to be compressed. When the portable electronic device 100 is still not placed on the placement plane, or is away from the placement plane (that is, is restored to a state shown in FIG. 3B), the terminal assembly P13 of the first conductive terminal P1 is pushed by a rebound force of the first spring P12, to cause the terminal assembly P13 to protrude from the base 120. In some embodiments, the first conductive terminal P1 is a POGO terminal structure.

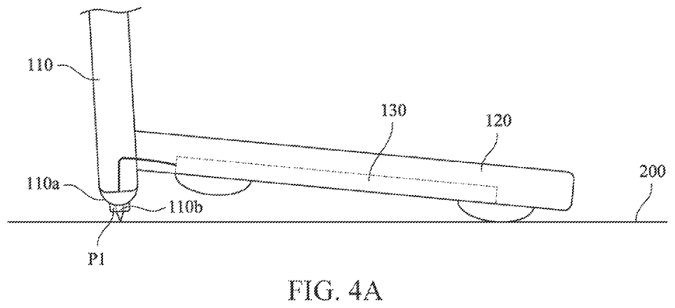

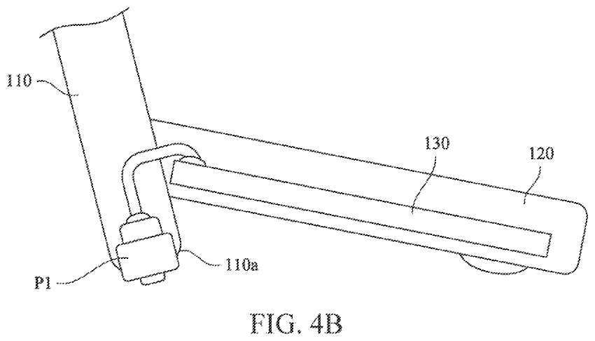

FIG. 4A and FIG. 4B are other schematic diagrams of the first conductive terminal P1. In an embodiment, instead, the first conductive terminal P1 is disposed in the display screen 110, and protrudes from a bottom 110a of the display screen 110. As shown in FIG. 4A, the first conductive terminal P1 protrudes from the bottom 110a of the display screen 110, and is displaced along a slot 110b of the bottom 110a of the display screen 110, so that the contact end of the first conductive terminal P1 is elastically pushed into the display screen 110 when the first conductive terminal P1 abuts against the power supply device 200. A composition structure of the first conductive terminal P1 is the same as the embodiments of FIG. 3A and FIG. 3B (that is, includes the first spring and the terminal assembly, or is implemented as the POGO terminal structure). Therefore, details are not described herein again.

As shown in FIG. 4B, the contact end of the first conductive terminal P1 is made of a non-slip material, to serve as a support pad of the display screen 110. The structure of the first conductive terminal P1 is implemented by the embodiments of FIG. 2A and FIG. 2B or FIG. 3A to FIG. 3C. Therefore, details are not described herein again. In addition, in an embodiment, a structure and a mounting position of the second conductive terminal P2 are the same as those of the first conductive terminal P1 in the embodiments shown in FIG. 3A to FIG. 3C, FIG. 4A, and FIG. 4B. Therefore, details are also not described herein again.

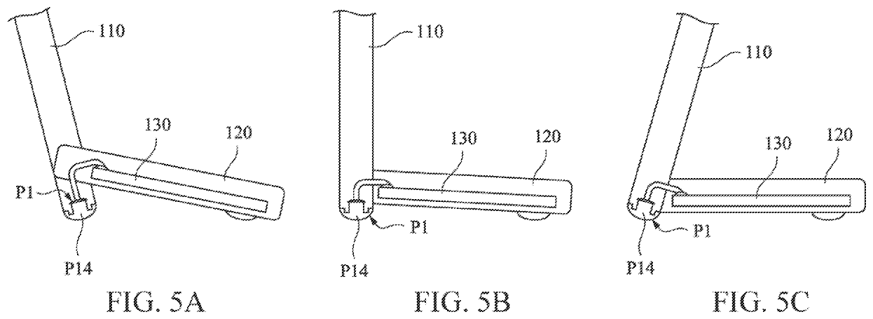

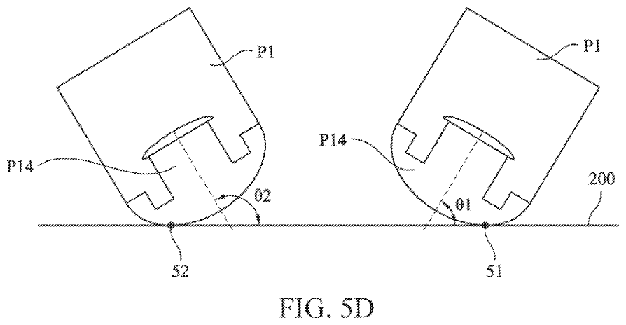

FIG. 5A to FIG. 5C are schematic diagrams of a first conductive terminal P1 according to some embodiments of the present disclosure. The first conductive terminal P1 includes an annular electrode P14. The annular electrode P14 includes a circular arc surface, to serve as the contact end of the first conductive terminal. In an embodiment, the first conductive terminal P1 is disposed at the bottom of the display screen 110, and when a rotation angle of the display screen 110 relative to the base 120 changes, contact positions between the annular electrode P14 and the charging electrodes E also change accordingly. As shown in FIG. 5D, when there is a first rotation angle θ1 between the display screen 110 and the base 120, the annular electrode P14 is in contact with the charging electrodes E through a contact point 51. When there is a second rotation angle θ2 between the display screen 110 and the base 120, the annular electrode P14 is in contact with the charging electrodes E through a contact point 52.

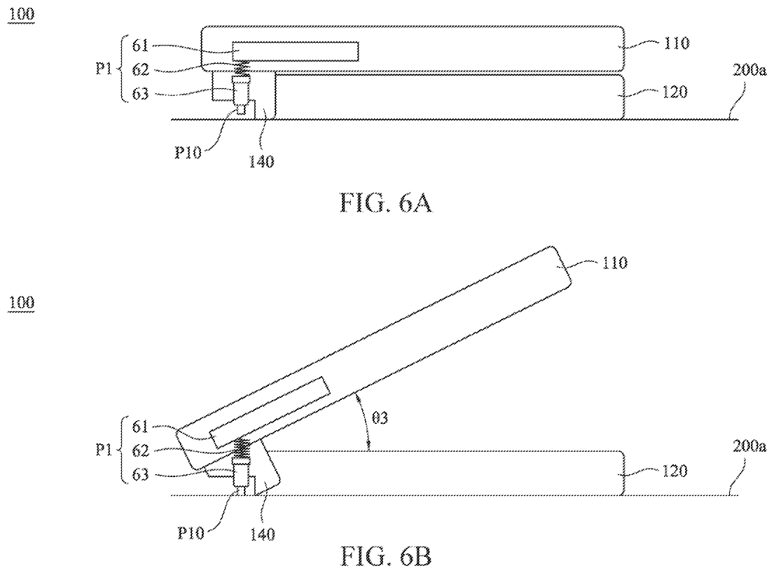

FIG. 6A and FIG. 6B are schematic diagrams of a first conductive terminal P1 according to some embodiments of the present disclosure. The first conductive terminal P1 is disposed at the bottom of the display screen 110 or the base 120, and a contact end P10 of the first conductive terminal P1 is exposed on the base 120. When the display screen 110 is closed on the base 120, the contact end P10 of the first conductive terminal P1 does not protrude from the bottom of the base 120. When the portable electronic device 100 is placed on the placement plane 200a, and the display screen 110 rotates relative to the base 120 beyond a predetermined angle, the first conductive terminal P1 is displaced in a direction away from the display screen 110, to come into contact with the charging electrodes E. In other words, when the base 120 is placed on the placement plane 200a of the power supply device 200, and the display screen 110 rotates and is no longer closed on the base 120, the contact end P10 of the first conductive terminal P1 is pushed out of the portable electronic device 100, to come into actual contact with the charging electrodes E.

Specifically, the first conductive terminal P1 includes a support assembly 61, a terminal spring 62, and a terminal assembly 63. The support assembly is disposed in the display screen 110, and in an embodiment, is fixed to the casing of the display screen 110. A first end of the terminal spring 62 is connected to the support assembly 61. The terminal assembly 63 is connected to a second end of the terminal spring 62, and is disposed in the base 120. As shown in FIG. 6A, when the display screen 110 is closed on the base 120, the terminal assembly 63 is located in the base 120, and the terminal spring 62 is maintained in a relaxed state. When the display screen 110 rotates relative to the base 120, and the rotation angle exceeds an expected angle θ3, the terminal spring 62 is pushed/compressed due to the rotation of the support assembly 61 with the display screen 110. In this case, the terminal spring 62 pushes the terminal assembly 63 to move out of the portable electronic device 100 (in an embodiment, move out of the base 120). When the base 120 is placed on the placement plane 200a of the power supply device 200, the contact end P10 of the first conductive terminal P1 is affected by a pushing force of the terminal spring 62 and is displaced in the direction away from the display screen 110, to come into contact with the charging electrodes E.

In some embodiments, the support assembly 61 of the first conductive terminal P1 is disposed in the display screen 110, the terminal spring 62 and the terminal assembly 63 are disposed in the base 120, and the terminal spring 62 is connected to the support assembly 61. In other embodiments, the terminal assembly 63 is disposed in a pivot assembly 140 of the portable electronic device 100, and the pivot assembly 140 is configured to connect the display screen 110 and the base 120. However, the terminal assembly 63 inside the display screen 110 does not rotate with the display screen 110 (in an embodiment, is fixed to a pivot shaft or connected to the base 120). A mode of a pivot connection between the display screen 110 and the base 120 is understood by a person skilled in the art. Therefore, details are not described herein again.

In an embodiment, the structure of the first conductive terminal P1 is the same as the structure of the second conductive terminal P2. In other words, the foregoing structures shown in FIG. 4A to FIG. 6B are also applicable to the second conductive terminal P2. In addition, the components or technical features in the foregoing embodiments is combined with each other, and are not limited by the order of text description or the order of figure presentation in the present disclosure.

Although the content of the present disclosure has been disclosed above by using the implementations, the implementations are not used to limit the content of the present disclosure. Any person skilled in the art makes various variations and modifications without departing from the spirit and scope of the content of the present disclosure. Therefore, the protection scope of the content of the present disclosure is defined by the appended claims.

What is claimed is:

1. A portable electronic device, adapted to match a power supply device comprising a plurality of charging electrodes, the portable electronic device comprising:
a display screen;
a base, connected to the display screen, to cause the display screen to rotate relative to the base; and
a charging circuit, disposed in the base and comprising a first conductive terminal and a second conductive terminal, wherein the first conductive terminal and the second conductive terminal are exposed on a bottom surface of the portable electronic device, and when the portable electronic device is placed on the power supply device, the first conductive terminal and the second conductive terminal come into contact with the charging electrodes, to form electrical connections and receive charging power.

2. The portable electronic device according to claim 1, wherein when the portable electronic device is placed on the power supply device, the first conductive terminal and the second conductive terminal are flush with a bottom surface of the base.

3. The portable electronic device according to claim 2, wherein the first conductive terminal comprises a first spring, and when the portable electronic device is away from the power supply device, the first spring drives the first conductive terminal, to cause the first conductive terminal to protrude from the bottom surface of the base or a bottom of the display screen.

4. The portable electronic device according to claim 3, wherein the first conductive terminal further comprises a pad body, and the first conductive terminal protrudes from the pad body.

5. The portable electronic device according to claim 1, wherein the first conductive terminal further comprises an annular electrode, and the annular electrode comprises a circular arc surface.

6. The portable electronic device according to claim 5, wherein when a rotation angle of the display screen relative to the base changes, contact positions between the annular electrode and the charging electrodes also accordingly change.

7. The portable electronic device according to claim 1, wherein when the display screen rotates relative to the base beyond a predetermined angle, the first conductive terminal is displaced, to come into contact with the charging electrodes.

8. The portable electronic device according to claim 7, wherein the first conductive terminal comprises:
a support assembly, disposed in the display screen;
a terminal spring, wherein a first end of the terminal spring is connected to the support assembly; and
a terminal assembly, connected to a second end of the terminal spring, wherein when the display screen rotates relative to the base, the support assembly pushes the terminal spring, to cause the terminal spring to push the terminal assembly to move.

9. The portable electronic device according to claim 1, wherein a bottom of the base comprises a first slot and a second slot, the first conductive terminal and the second conductive terminal are disposed in the first slot and the second slot, and when the first conductive terminal and the second conductive terminal come into contact with the charging electrodes, the first conductive terminal and the second conductive terminal are displaced along the first slot and the second slot.

10. The portable electronic device according to claim 1, wherein a distance between the first conductive terminal and the second conductive terminal is at least greater than 5 cm.

11. A charging system, comprising:
a portable electronic device, comprising a display screen, a base, and a charging circuit, wherein the base is connected to the display screen, to cause the display screen to rotate relative to the base; the charging circuit is disposed in the base and comprises a first conductive terminal and a second conductive terminal, and the first conductive terminal and the second conductive terminal are exposed on a bottom surface of the portable electronic device; and
a power supply device, comprising a plurality of charging electrodes, wherein when the portable electronic device is placed on the power supply device, the first conductive terminal and the second conductive terminal come into contact with at least two of the charging electrodes to form electrical connections, to cause the power supply device to supply charging power to the portable electronic device through the charging electrodes, the first conductive terminal and the second conductive terminal.

12. The charging system according to claim 11, wherein when the portable electronic device is placed on the power supply device, the first conductive terminal and the second conductive terminal are flush with a bottom surface of the base.

13. The charging system according to claim 12, wherein the first conductive terminal comprises a first spring, and when the portable electronic device is away from the power supply device, the first spring drives the first conductive terminal, to cause the first conductive terminal to protrude from the bottom surface of the base or the display screen.

14. The charging system according to claim 13, wherein the first conductive terminal further comprises a pad body, and the first conductive terminal protrudes from the pad body.

15. The charging system according to claim 11, wherein the first conductive terminal further comprises an annular electrode, and the annular electrode comprises a circular arc surface.

16. The charging system according to claim 15, wherein when a rotation angle of the display screen relative to the base changes, contact positions between the annular electrode and the charging electrodes also accordingly change.

17. The charging system according to claim 11, wherein when the display screen rotates relative to the base beyond a predetermined angle, the first conductive terminal is displaced, to come into contact with the charging electrodes.

18. The charging system according to claim 12, wherein the first conductive terminal comprises:
a support assembly, disposed in the display screen;
a terminal spring, wherein a first end of the terminal spring is connected to the support assembly; and
a terminal assembly, connected to a second end of the terminal spring, wherein when the display screen rotates relative to the base, the support assembly pushes the terminal spring, to cause the terminal spring to push the terminal assembly to move.

19. The charging system according to claim 11, wherein the power supply device further comprises:
a charging controller, electrically connected to the charging electrodes and configured to determine two of the charging electrodes that are in contact with the first conductive terminal and the second conductive terminal, to charge the portable electronic device through the two charging electrodes.

20. The charging system according to claim 19, wherein a distance between the first conductive terminal and the second conductive terminal is greater than a diagonal length of each of the charging electrodes.
